(19) United States
(12) Patent Application Publication
(10) Pub. No.: US 2015/0314756 A1
(43) Pub. Date: Nov. 5, 2015

(54) PASSIVE ACCESS SYSTEM FOR A MOTOR VEHICLE AND CORRESPONDING METHOD

(71) Applicant: HUF HÜLSBECK & FÜRST GMBH & CO. KG, Velbert (DE)

(72) Inventors: Stefan MOENIG, Schwelm (DE); Joerg SIMON, Wuelfrath (DE)

(73) Assignee: Huf Huelsbeck & Fuerst GmbH & Co. KG, Velbert (DE)

(21) Appl. No.: 14/651,973

(22) PCT Filed: Jan. 6, 2014
(86) PCT No.: PCT/EP2014/050078

§ 371 Date: Jun. 12, 2015

(30) Foreign Application Priority Data
Jan. 8, 2013 (DE) 10 2013 100 127.0

(51) Int. Cl. B60R 25/24; H04B 5/00; G07C 9/00

(52) U.S. Cl. CPC B60R 25/24; G07C 9/00007; G07C 9/00309; H04B 5/0025; G07C 2009/00769

(57) ABSTRACT

A system for controlling access to a motor vehicle includes a vehicle-side control device which is coupled to a transmitter receiver device for wireless communication with a wireless ID provider. Upon actuation, a vehicle-side activation device transmits an activation signal to the ID provider. In the vehicle, an NFC (near field communication) device is provided in the region of the outer shell of the vehicle and is coupled to the activation device to actuate the activation device for transmitting the wake up signal, dependent upon an NFC data exchange between a vehicle-side NFC device and an external NFC communication device. Also disclosed is a related method for controlling access to a motor vehicle.

The invention relates to a passive access system of a motor vehicle. In particular, the invention relates to an access system in which a portable ID provider is carried by a user, wherein the ID provider has components for executing an authorization communication with a motor vehicle-side control device.

Portable identification providers, also referred to as electronic keys or ID providers, serve to enable an owner or carrier of the identification provider to access a motor vehicle, or to lock the motor vehicle, without the user having to actively actuate input buttons of the identification provider. The user needs only to carry the identification provider (by way of example, in the clothing of the user, or a bag carried by the user) in order to obtain access to vehicle functions.

These functionalities are referred to as “passive keyless-entry” or, when starting up the vehicle, “keyless-go.” In contrast to a conventional remote control, with the “passive keyless-entry function,” no active operation of the wireless identification provider is needed in order to lock or unlock (close or open) the locking device, or to unlock the anti-theft device. By way of example, when the door handle of the vehicle is approached, or the door handle of the vehicle is actuated, a communication between the motor vehicle and the identification provider is initiated and, with a positive identification check (authentication), the electric unlocking of the locking device is activated. This means that the user carrying a valid identification provider can open his motor vehicle without having to actively actuate the identification provider.

For keyless-go systems, it is known to provide antennas at selected positions on a vehicle, the range of which, also referred to as the lock-in range, defines the functional range of an associated wireless authentication communication channel, by means of which the access and/or driver authorization checking communication procedure occurs for a vehicle locking system, or an electronic anti-theft device, respectively. A communication procedure of this type is executed successfully when a valid authentication element for the vehicle is located in the functional range of the communication channel defined in this manner. A specific antenna device of this type is described in the patent specification DE 195 42 411 C2. It is known therefrom, from among other sources, that at least one pair of individual antennas can be disposed beneath a back shelf, in the trunk, or in the vicinity thereof, in order to emit signals to an authentication element in the trunk or in the immediate vicinity thereof, i.e. the lock-in range thus lies in or around the trunk.

A locking system is described in the patent application DE 41 23 654 A1 . With this locking system, by triggering a locking command, a query-response dialog is triggered between a vehicle-side antenna unit and a wireless transponder, which serves as an authentication element, and it is determined whether the transponder is located within the receiving range of the one or more antennas inside the relevant vehicle interior region, or is outside the vehicle. The commanded locking is then first executed when it has been determined that the transponder is located outside the vehicle, and not inside. Furthermore, a locking system is referred to as known in this document, with which a corresponding query-response dialog for identifying the transponder does not immediately trigger a locking command, but rather, first triggers this command after a defined waiting period, and when recognized, a warning signal is generated.

If access to a vehicle is desired, the following sequence occurs, by way of example:

The user carrying the identification provider approaches the driver door of the motor vehicle, and grasps a door handle. In this moment, the proximity of the user is detected by a sensor attached to the door (by way of example, a capacitive proximity sensor mounted in the door handle), and a motor vehicle-side control device is notified. Fundamentally, such a detection and notification of an approaching user is also then carried out when the user is not authorized, and thus is not carrying an appropriate identification provider. A detection of a proximity and corresponding notification would then also be conceivable when any body approaches the sensor in a specific manner. For this reason, an access authorization is to be checked, before the door is unlocked and an actuation of the door handle for opening the door is permitted by the motor vehicle-side control device. An exchange of radio signals, and thus a dialog, takes place, for this purpose, between the motor vehicle-side control device and a microcontroller contained in the identification provider. This dialog can start, as a rule, with a high frequency (HF) query signal on the part of the motor vehicle-side control device, and it can be continued with an HF response signal emitted from the identification provider. In this case, the identification provider, however, must contain an HF receiver that is permanently active. A further disadvantage of such an HF communication consists of the difficulty in designing a precisely bordered spatial reception range in the vicinity of the vehicle. In order to then enable an activation of the identification provider when said identification provider is located in a predefined spatial region (adjacent to the vehicle door), it is typical in the prior art (but not necessary), that the motor vehicle-side control device first emits a wake-up signal in the LF range (e.g. at 125 kHz), via a low frequency (LF) transmitter having an associated transmitter coil, wherein the transmitter coil is disposed such (in the door handle, for example) that a predefined transmission range surrounding the door handle, of a few meters for example, is obtained. The identification provider, on the other hand, is equipped with an associated LF receiver, which, in addition to LF amplifier circuits, comprises receiver coils.

An output of the LF receiver is coupled to an input of the microcontroller. When the identification provider that the user is carrying, equipped with an LF receiver circuit, then, when the user takes hold of the door handle, is located at the same time in the transmission range of the LF transmitter coil of the motor vehicle-side control device, it receives a wake-up signal in the LF range, which is transmitted, immediately after detecting the accessing by the operator, or his proximity, from the motor vehicle-side control device via the transmitter coil. The received LF wake-up signal serves to awaken the microcontroller, and to cause said microcontroller to initiate, in a program controlled manner, the HF signal dialog with the motor vehicle-side control device. For this reason, the microcontroller and the HF transmitter and receiver circuits can remain switched in a standby status having lower power consumption.

The detection of the proximity of a user, e.g. through capacitive sensors or infrared sensors, is convenient, but also a bit specific. As described above, fundamentally any proximity can trigger a wake-up query on the part of the vehicle to the ID provider.

The invention addresses the object of improving the security and effectiveness of the access process.

This object shall be achieved according to the invention by means of a method according to claim 1, and a method according to claim 5.

According to the invention, a system for controlling access to a motor vehicle has a vehicle-side control device, which is coupled with transmitting and receiving means for providing a wireless communication with a wireless ID provider. Control devices of this type have meanwhile been implemented in numerous vehicle models and the components and the methods for executing a dialog of this type between an ID provider and a vehicle-side control device are known.

The vehicle-side wake-up device already described above, which is provided in the system, in accordance with the invention, is also known. The vehicle-side wake-up device can be any device for transmitting wireless signals, which the ID provider carried by the user can receive. In particular, electromagnetic waves can be emitted, preferably in the low frequency range.

The system according to the invention is characterized in that an NFC communication device is disposed in the vehicle, in the region of the car body shell, which is activated for NFC coupling to an external device.

The NFC (Near Field Communication) technology, known per se, enables a communication at close range, without contact. The method for data transmission used thereby is also used in a similar form for non-contacting chip cards, and enables a data exchange at a distance of up to a few centimeters. A data exchange normally occurs simply through the proximity of two end devices provided with an NFC interface. The NFC technology is also used in cellular telephones in order to expand their functionality. Wireless end devices of the newer generation already have, in some cases, an additional contact-free interface for close range applications. For this, an antenna is integrated in the portable end device, by means of which a data exchange occurs with another external device, likewise suited for NFC communication. The use of NFC devices in vehicles for various purposes is also already fundamentally known.

This NFC device on the vehicle is directly or indirectly coupled to the wake-up device, in accordance with the invention, such that the wake-up device can be activated as a function of the NFC dialog.

According to the invention, the functions that have been assumed in vehicles so far, for example, by capacitive sensors, are thus replaced or supplemented by an NFC device in the vehicle. While erroneous identifications may occur with proximity sensors, and furthermore, there is no possibility for checking who has actually triggered the proximity sensor, the NFC device is suited for differentiated evaluation of NFC data exchange with an external device. The wake-up device is only activated when a user actually wants to cause the opening of the vehicle, and for this, brings an NFC capable communication device into the vicinity of the NFC device in the vehicle. The important thing thereby is that the ID provider continues to play a role in the access dialog. The NFC communication can trigger the wake-up process for the ID provider, but it does not, however, entirely replace the authorization dialog. As a result, a further security component is introduced in the access query for the vehicle. By this means, erroneous recognitions and erroneous communications are eliminated.

The NFC device can be disposed in the vehicle at any, readily accessible, location. In a preferred embodiment of the invention, the NFC device is disposed in a hinged closure handle on the vehicle, in particular in the door handle. By disposing the NFC device in a door handle, the query is enabled there where the user most frequently attempts to obtain access. If, for example, the user is holding an NFC capable cellular telephone, he can then use this hand to actuate the door handle, in order, in a continuous process, to initiate the awakening of the ID provider, as well as to open the door after a successful authorization by the ID provider.

The NFC authorization can thus be combined with an existing access control system as a trigger for the wake-up process, as well as with existing proximity sensors on the vehicle. It can be designed such, for example, that the user can select whether a capacitive sensor system should detect the proximity, or the NFC system should be active, in order to execute the awakening of the ID provider.

In a preferred design, the vehicle-side wake-up device is an LF transmitter. LF transmitters are a proven technology, and can also, themselves, be disposed in the relevant vehicle parts, in particular door handles, in order to transmit wake-up signals to the ID provider. LF transmitters of this type can be accommodated in a structural unit, together with the associated NFC communication device, in a door handle.

In a further development of the invention, the NFC communication device is coupled to the vehicle central control device. The NFC device is coupled indirectly to the wake-up device, via this central control device. The central control device is notified of an NFC data exchange initiated with an external NFC device, and the wake-up device can be triggered from there, in order to transmit the wake-up signal. This design is particularly advantageous when a vehicle-side triggering of the wake-up device is supposed to occur on the basis of the contents of the data exchange. In particular, it is possible to store the information regarding which NFC device is authorized to trigger the wake-up process in the central processing unit. By way of example, cellular telephones, or other appropriately suitable devices can be programed by users as legitimate devices, such that an identification of the device can occur in the data exchange. Only then, when the central control device has an appropriate entry for a legitimated NFC device, is the wake-up procedure for the ID provider triggered. As a result, a multi-step security procedure is provided, which then only allows access when both the external NFC device has been legitimated as valid, as well as the subsequently queried ID provider.

In accordance with the device according to the invention, and in accordance with the method according to the invention, such authorization of an external NFC device can occur by means of a programming of the system and/or the external NFC device initiated by the user. If, for example, an application, supplied by the vehicle manufacturer, is installed on the external NFC device, this application can be designed to communicate with the vehicle-side NFC device. An authorization of a wireless device can occur on the vehicle via this application, together with the vehicle. By way of example, in order to do this, a user must insert his ID provider in a receiving slot on the vehicle, bring the wireless device into the range of the vehicle-side NFC device, and select an authorization function in the application. In this manner, every user can contribute a substantial step to the security for the access control. This combination of authorizing the wireless device and requiring an ID provider is significantly more secure than the authorization for access via an NFC communication alone, i.e. unlocking the vehicle by NFC telephone, without an ID provider. The important thing is that, firstly, the ID provider is never awakened if the first authorization step has not been carried out.

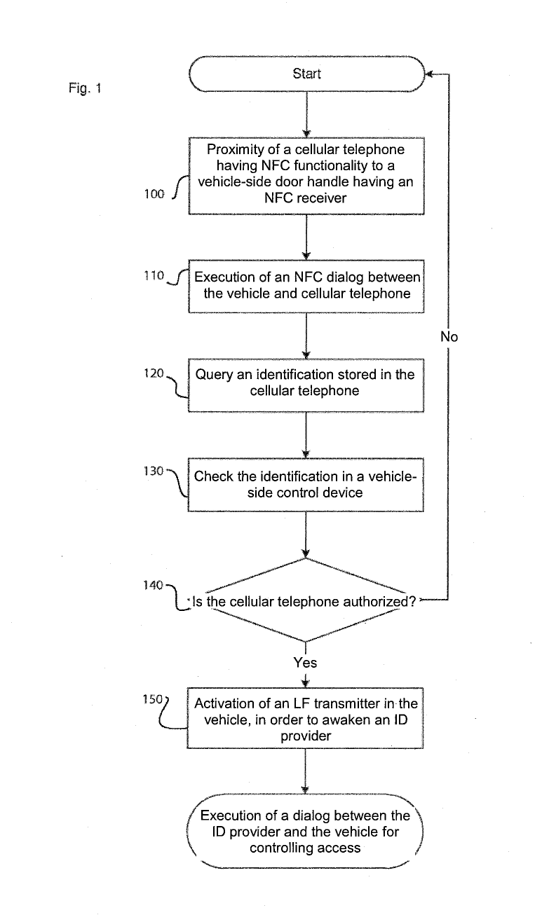

FIG. 1 shows, schematically, the sequence of the method according to the invention in one embodiment, and with a device according to the invention, or a system according to the invention, respectively.

A user seeking access to a vehicle approaches the vehicle and holds his cellular telephone having NFC functionality against a vehicle-side door handle, which has an NFC communication device (step 100). When the cellular telephone is in the proximity of the door handle, an NFC dialog is initiated, either automatically or by the user. During the dialog, identification data stored in the cellular telephone is queried by the vehicle-side device (step 120). In the vehicle, the queried identification data, or information derived therefrom, are transmitted to the central processing unit and compared with data stored there (step 130).

In step 140, it is checked and decided whether the cellular telephone is registered in the vehicle as an authorized cellular telephone. If this is not the case, the process is interrupted, and in particular, no wake-up is triggered by the wake-up device.

If the cellular telephone is acknowledged as authorized, the central vehicle-side control device activates a vehicle-side wake-up device having an LF transmitter coil (step 150). The LF transmitter coil transmits a low frequency (LF) signal having a limited range surrounding the vehicle. If there is an ID provider within the reception range, it is awakened and begins an authorization dialog in high frequency range between the ID provider and the vehicle-side control device, such as is known from the prior art. If this authorization dialog is successfully executed, the vehicle-side control device then activates the locking system in order to unlock the vehicle. If there is no successful communication between the ID provider and the vehicle-side control device, access to the vehicle is denied.

It is clear that a two-step authorization control can be executed with the method according to the invention, wherein one of the steps, specifically the NFC access control, can fundamentally be designed as a security step that can be modified and adjusted by the user. This enables the user to control the vehicle in a flexible manner, regarding who has access to the vehicle. By way of example, an ID provider can be made available to all members of the family if the vehicle is intended for family use. By means of the additional step, of the NFC authorization, however, a respective cellular telephone can be configured, in an adjustable manner, as authorized or not authorized for the access to the vehicle. Because this setting can be accessed and modified at any time by the user, and optionally, can even be linked to temporal authorization periods, there is always a fundamentally high level of security control for the access (by means of the ID provider), which, when desired, is supplemented by an access control via the NFC access control. Because the ID provider is first not even awakened, and the authorization dialog is not initiated, there is a particularly substantial security level, as long as the NFC device is not activated appropriately.

1. A system for controlling access to a motor vehicle, wherein the system comprises: a vehicle-side control device, which is coupled with transmitter/receiver means for wireless communication with a wireless ID provider, a vehicle-side wake-up device, which transmits a wake-up signal to the ID provider when activated, characterized in that an NFC (Near Field Communication) device is formed on the vehicle, disposed in the region of the car body shell, which is coupled to the wake-up device, in order to activate the wake-up device for transmitting the wake-up signal, dependent on an NFC data exchange between a vehicle-side NFC device and an external NFC communication device.

2. The system according to claim 1, wherein the vehicle-side NFC device is disposed in a hinged closure handle of the vehicle, in particular a door handle.

3. The system according to claim 1, wherein the vehicle-side wake-up device is an LF transmitter.

4. The system according to claim 1, wherein the vehicle-side NFC device is coupled to the vehicle-side control device, in order to activate the wake-up device via the control device.

5. A method for controlling access to a motor vehicle, comprising the steps: approach of an external NFC communication device to a vehicle-side NFC (Near Field Communication) device disposed in the region of the car body shell of the vehicle, initiation and execution of an NFC data exchange between the external NFC device and the vehicle-side NFC device, activation of a vehicle-side wake-up device, dependent on the executed data exchange, wherein the wake-up device then transmits a radio wake-up signal to a wireless ID provider in order to initiate an authorization dialog between the ID provider and the vehicle.

6. The method according to claim 5, wherein authorization data is transmitted to the vehicle-side NFC device during the data exchange between the external NFC device and the vehicle-side NFC device, wherein the wake-up device is only activated to transmit the wake-up signal when the authorization data corresponds to the vehicle-side stored data.

7. The method according to claim 5, wherein an authorization dialog between the ID provider and a vehicle-side control device is executed after the awakening of the ID provider.

8. The method according to claim 5, wherein data from the data exchange executed between the external NFC device and the vehicle-side NFC device are transmitted to the control device, and the wake-up device is activated by means of the control device.

9. The method according to claim 5, wherein the wake-up device is activated independently of the content of the data exchange when an NFC communication setup is executed.

10. The system according to claim 2, wherein the vehicle-side wake-up device is an LF transmitter.

11. The system according to claim 2, wherein the vehicle-side NFC device is coupled to the vehicle-side control device, in order to activate the wake-up device via the control device.

12. The system according to claim 3, wherein the vehicle-side NFC device is coupled to the vehicle-side control device, in order to activate the wake-up device via the control device.

13. The method according to claim 6, wherein an authorization dialog between the ID provider and a vehicle-side control device is executed after the awakening of the ID provider.

14. The method according to claim 6, wherein data from the data exchange executed between the external NFC device and the vehicle-side NFC device are transmitted to the control device, and the wake-up device is activated by means of the control device.

15. The method according to claim 7, wherein data from the data exchange executed between the external NFC device and the vehicle-side NFC device are transmitted to the control device, and the wake-up device is activated by means of the control device.
